(19) United States
(12) Patent Application Publication
(10) Pub. No.: US 2025/0031123 A1
(43) Pub. Date: Jan. 23, 2025

(54) METHOD AND APPARATUS FOR SUBSEQUENT CONDITIONAL PSCELL CHANGE IN A WIRELESS COMMUNICATION SYSTEM

(71) Applicant: Samsung Electronics Co., Ltd., Suwon-si (KR)

(72) Inventors: June HWANG, Suwon-si (KR); Beomsik BAE, Suwon-si (KR)

(21) Appl. No.: 18/774,173

(22) Filed: Jul. 16, 2024

(30) Foreign Application Priority Data
Jul. 18, 2023 (KR) 10-2023-0093454

(51) Int. Cl. H04W 36/36; H04W 36/00; H04W 76/20

(52) U.S. Cl. CPC H04W 36/362; H04W 36/0058; H04W 36/0061; H04W 76/20

(57) ABSTRACT

A method performed by a master node (MN) in a wireless communication system is provided. The method includes receiving, from a source secondary node (S-SN), a secondary node (SN) change required message for initiating a subsequent conditional primary secondary cell group cell (PSCell) addition and change (CPAC), transmitting, to a plurality of candidate SNs, an SN addition request message, receiving, from the plurality of candidate SNs, an SN addition request acknowledge message, transmitting, to the S-SN and the plurality of candidate SNs, the information on the at least one PSCell, and receiving, from the plurality of candidate SNs, first information on an updated configuration for the at least one PSCell.

### CROSS-REFERENCE TO RELATED APPLICATION(S)

This application is based on and claims priority under 35 U.S.C. § 119 (a) of a Korean patent application number 10-2023-0093454, filed on Jul. 18, 2023, in the Korean Intellectual Property Office, the disclosure of which is incorporated by reference herein in its entirety.

### BACKGROUND

### 1. Field

The disclosure relates to a wireless communication (or mobile communication) system. More particularly, the disclosure relates to the provision and evaluation of conditions upon a conditional primary secondary cell group (SCG) cell (PSCell) change.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication (or mobile communication) systems as described above, various services can be provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for a conditional PSCell change in a wireless communication (or mobile communication) system.

Additional aspects will be set forth in part in the description which follows and, in part, will be apparent from the description, or may be learned by practice of the presented embodiments.

In accordance with an aspect of the disclosure, a method performed by a master node (MN) in a wireless communication system is provided. The method includes receiving, from a source secondary node (S-SN), a secondary node (SN) change required message for initiating a subsequent conditional primary secondary cell group cell (PSCell) addition and change (CPAC), transmitting, to a plurality of candidate SNs, an SN addition request message including at least one of a list of PSCell candidates for the plurality of candidate SNs or information on the plurality of candidate SNs, receiving, from the plurality of candidate SNs, an SN addition request acknowledge message including at least one of information on at least one PSCell among the list of the PSCell candidates or information on a first execution condition for the at least one PSCell, transmitting, to the S-SN and the plurality of candidate SNs, the information on the at least one PSCell, and receiving, from the plurality of candidate SNs, first information on an updated configuration for the at least one PSCell.

In accordance with an aspect of the disclosure, a method performed by a secondary node (SN) in a wireless communication system is provided. The method includes receiving, from a master node (MN), an SN addition request message including at least one of a list of PSCell candidates for a plurality of candidate SNs or information on the plurality of candidate SNs, identifying at least one PSCell among the list of the PSCell candidates, transmitting, to the MN, an SN addition request acknowledge message including at least one of information on the at least one PSCell or information on a first execution condition for the at least one PSCell, receiving, from the MN, the information on the at least one PSCell, and transmitting, to the MN, first information on an updated configuration for the at least one PSCell.

In accordance with an aspect of the disclosure, a master node (MN) in a wireless communication system is provided. The MN includes a transceiver, and at least one processor coupled with the transceiver and configured to receive, from a source secondary node (S-SN), a secondary node (SN) change required message for initiating a subsequent conditional primary secondary cell group cell (PSCell) addition and change (CPAC), transmit, to a plurality of candidate SNs, an SN addition request message including at least one of a list of PSCell candidates for the plurality of candidate SNs or information on the plurality of candidate SNs, receive, from the plurality of candidate SNs, an SN addition request acknowledge message including at least one of information on at least one PSCell among the list of the PSCell candidates or information on a first execution condition for the at least one PSCell, transmit, to the S-SN and the plurality of candidate SNs, the information on the at least one PSCell, and receive, from the plurality of candidate SNs, first information on an updated configuration for the at least one PSCell.

In accordance with an aspect of the disclosure, a secondary node (SN) in a wireless communication system is provided. The SN includes a transceiver, and at least one processor coupled with the transceiver and configured to receive, from a master node (MN), an SN addition request message including at least one of a list of PSCell candidates for a plurality of candidate SNs or information on the plurality of candidate SNs, identify at least one PSCell among the list of the PSCell candidates, transmit, to the MN, an SN addition request acknowledge message including at least one of information on the at least one PSCell or information on a first execution condition for the at least one PSCell, receive, from the MN, the information on the at least one PSCell, and transmit, to the MN, first information on an updated configuration for the at least one PSCell.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a long-term evolution (LTE) system according to an embodiment of the disclosure;

FIG. 2 illustrates a radio protocol structure of an LTE system according to an embodiment of the disclosure;

FIG. 3 illustrates a structure of a next-generation mobile communication system according to an embodiment of the disclosure;

FIG. 4 illustrates a radio protocol structure of a next-generation mobile communication system according to an embodiment of the disclosure;

FIG. 5 is a block diagram showing the internal structure of a UE according to an embodiment of the disclosure;

FIG. 6 is a block diagram showing the configuration of an NR base station according to an embodiment of the disclosure;

FIG. 7 illustrates configurations of candidate primary secondary cell group (SCG) cells (PSCells) given based on subsequent conditional PSCell addition and change (subsCPAC) configurations and a condition relationship between the configurations, according to an embodiment of the disclosure;

FIG. 8 is a flow diagram of a secondary node (SN) initiated conditional PSCell change (CPC) according to an embodiment of the disclosure;

FIG. 9A is a flow diagram of an option according to an embodiment of the disclosure;

FIG. 9B is a conceptual diagram related to an option according to an embodiment of the disclosure;

FIG. 10A is a flow diagram of an option according to an embodiment of the disclosure;

FIG. 10B is a conceptual diagram related to an option according to an embodiment of the disclosure;

FIG. 11A is a flow diagram of an option according to an embodiment of the disclosure; and

FIG. 11B is a conceptual diagram related to an option according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments of the disclosure may include one or more processors.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5th generation mobile communication standard). The disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “evolved node B (eNB)” may be interchangeably used with the term “next generation Node B (gNB)” for the sake of descriptive convenience. That is, a base station described as “eNB” may indicate “gNB”. In addition, the term “terminal” may refer to not only mobile phones, NB-IoT devices, and sensors, but also other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), Institute of Electrical and Electronics Engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHZ or more, instead of transmitting signals using a transmission bandwidth up to 20 MHZ in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The above three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. Therefore, for the services supporting URLLC, a 5G system must provide a transmit time interval (TTI) shorter than those of other services, and also may require a design for assigning a large number of resources in a frequency band in order to secure reliability of a communication link. In embodiments of the disclosure, a master node (MN) may be interpreted as a master base station, and a secondary node (SN) may be interpreted as a secondary base station. Further, in an embodiment of the disclosure, the MN and SN may be different base stations or may be base stations utilizing different radio access technologies (RATs), and in some cases, the MN and SN may be base stations utilizing the same RAT. The MN and SN may also be distinguished using generic expressions such as a first base station, a second base station, and the like.

In embodiments of the disclosure, a radio resource control (RRC) message transmitted by the MN may be named an MN RRC message. In addition, RRC messages generated by the SN may be named SN RRC messages.

In release 16, the procedure of an intra-SN conditional PScell change (CPC) is initiated by the SN, and configurations of candidate target PScells are transferred to a UE through an RRC message of the SN. On the other hand, an inter-SN conditional PScell change of release 17 is initiated by the MN or SN and configurations of candidate target PScells are transferred to a UE through an RRC message of the MN. If the network is to provide the UE with configurations of both the intra-SN conditional PScell change of Rel-16 and the inter-SN conditional PScell change of Rel-17, the configuration, measurement, and condition evaluation of the candidate target PScells by the UE may be done in units of a specific number of candidate PScells. Therefore, the MN and SN should agree on the maximum number of conditional PScell change configurations that each of the MN and SN is responsible for. This ensures that the maximum number of conditional PScell change configurations and measurement values that can be operated according to a UE capability is not exceeded.

In addition, when transferring conditional PScell change configurations to the UE, the SN assigns IDs indicating each candidate target PScell configuration in the case of intra-SN, and the MN assigns the IDs in the case of inter-SN. If all candidate PScell change configurations are stored in a single storage, i.e., a variable, there may be conflicts between IDs due to different entities assigning the IDs.

Furthermore, when the UE is configured and operated with the two types of conditional PScell change described above, inter-SN CPC configurations may be deleted under specific conditions if the intra-SN CPC is successfully performed.

According to embodiments of the disclosure, the CPC configurations of the MN and SN may prevent the UE from performing operations beyond the UE capability. Further, errors due to duplicate IDs between multiple CPC configurations may be prevented. Furthermore, the inter-SN CPC configurations may be managed efficiently due to performing of the intra-SN CPC.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

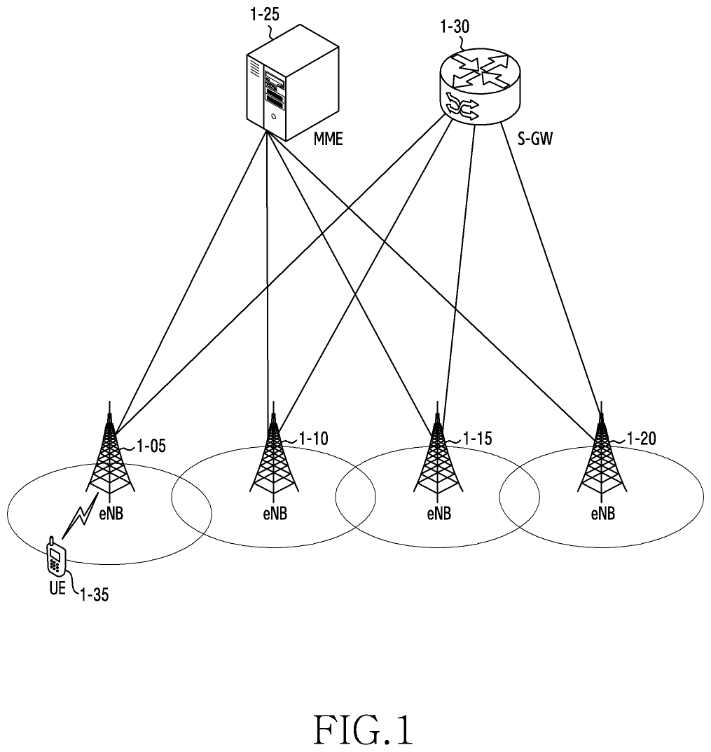

FIG. 1 illustrates a structure of an LTE system according to an embodiment of the disclosure.

Referring to FIG. 1, as illustrated therein, a radio access network of an LTE system may include next-generation base stations (evolved node Bs, hereinafter ENBs, node Bs, or base stations) 1-05, 1-10, 1-15, and 1-20, a mobility management entity (MME) 1-25, and a serving gateway (S-GW) 1-30. A user equipment (hereinafter UE or terminal) 1-35 may access an external network through the ENBs 1-05, 1-10, 1-15, and 1-20 and the S-GW 1-30.

Referring to FIG. 1, the ENBs 1-05 to 1-20 may correspond to conventional node Bs of a universal mobile telecommunication system (UMTS). The ENBs may be connected to the UE 1-35 through a radio channel, and perform more complicated roles than the conventional node Bs. In the LTE system, since all user traffic including real-time services, such as voice over IP (VOIP) via the Internet protocol, may be serviced through a shared channel. Thus, a device that collects state information, such as buffer states, available transmit power states, and channel states of UEs, and performs scheduling accordingly is required, and the ENBs 1-05 to 1-20 may serve as the device. In general, one eNB may control multiple cells. For example, in order to implement a transfer rate of 100 Mbps, the LTE system may use orthogonal frequency division multiplexing (OFDM) as a radio access technology in a bandwidth of, for example, 20 MHz. Obviously, the example given above is not limiting. Furthermore, the ENBs 1-05 to 1-20 may employ an adaptive modulation & coding (AMC) scheme for determining a modulation scheme and a channel coding rate according to a channel state of the UE. The S-GW 1-30 is a device that provides a data bearer, and may generate or remove a data bearer under the control of the MME 1-25. The MME is responsible for various control functions as well as a mobility management function for a UE, and may be connected to multiple base stations.

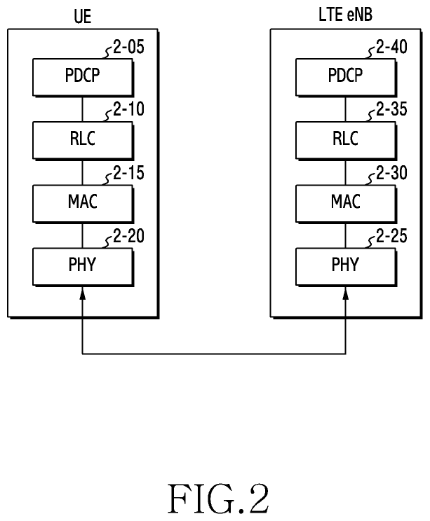

FIG. 2 illustrates a radio protocol structure of an LTE system according to an embodiment of the disclosure.

Referring to FIG. 2, a radio protocol of an LTE system may include a packet data convergence protocol (PDCP) 2-05 or 2-40, a radio link control (RLC) 2-10 or 2-35, a medium access control (MAC) 2-15 or 2-30, and a physical layer 2-20 or 2-25 in each of a UE and an ENB. Of course, the radio protocol of the LTE system may include a larger or smaller number of layers than the structure illustrated in FIG. 2.

According to an embodiment of the disclosure, the PDCP may serve to perform operations, such as IP header compression/reconstruction. The main functions of the PDCP may be summarized as follows. Obviously, the example given below is not limiting.
Header compression and decompression: robust header compression (ROHC) only
Transfer of user data
In-sequence delivery of upper layer protocol data units (PDUs) at PDCP re-establishment procedure for RLC acknowledged model (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

According to an embodiment of the disclosure, the radio link control (RLC) 2-10 or 2-35 may reconfigure a PDCP protocol data unit (PDU) into an appropriate size to perform an automatic repeat request (ARQ) operation. The main functions of the RLC may be summarized as follows. Obviously, the example given below is not limiting.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

According to an embodiment of the disclosure, the MAC 2-15 or 2-30 may be connected to several RLC layer devices configured in a single terminal, and multiplex RLC PDUs to a MAC PDU and demultiplex a MAC PDU to RLC PDUS. The main functions of the MAC are summarized as follows. Obviously, the example given below is not limiting.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through Hybrid ARQ (HARQ)
Priority handling between logical channels of one UE
Priority handling between UEs by means of dynamic scheduling
MBMS service identification
Transport format selection
Padding

According to an embodiment of the disclosure, the physical layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the example given above is not limiting.

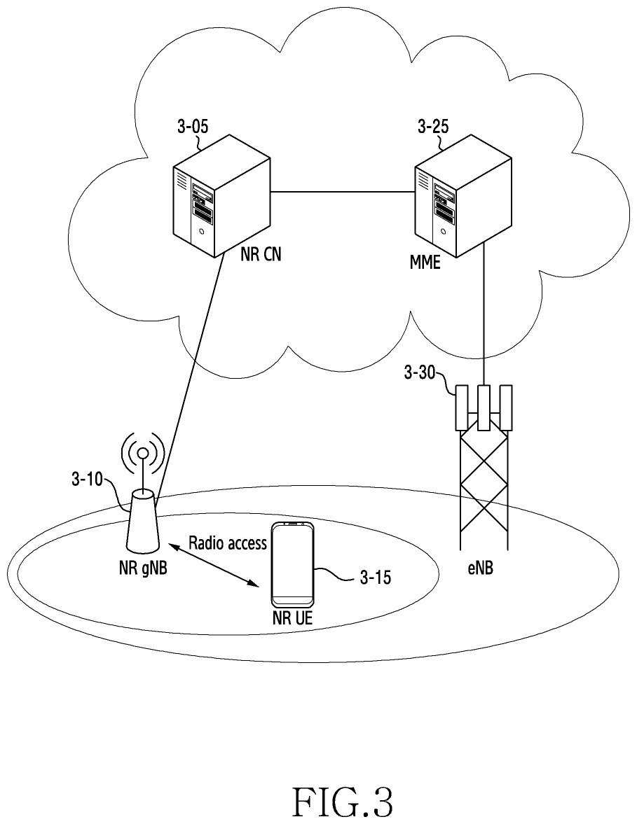

FIG. 3 illustrates a structure of a next-generation mobile communication system according to an embodiment of the disclosure.

Referring to FIG. 3, a radio access network of a wireless communication system (hereinafter next-generation mobile communication system, NR, or 5G) may include a new radio node B (hereinafter NR gNB or NR base station) 3-10, and a new radio core network (NR CN) 3-05. A new radio user equipment (NR UE or NR terminal) 3-15 may access an external network via the NR gNB 3-10 and the NR CN 3-05.

In FIG. 3, the NR gNB 3-10 may correspond to an evolved node B (eNB) of a conventional LTE system. The NR gNB 3-10 may be connected to the NR UE 3-15 through a radio channel and provide outstanding services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR NB 3-10 may serve as the device. In general, one NR gNB may control multiple cells.

In order to implement ultrahigh-speed data transfer beyond the current LTE, the next-generation mobile communication system may provide a wider bandwidth than the existing maximum bandwidth. in addition, the next-generation mobile communication system may employ an orthogonal frequency division multiplexing (OFDM) as a radio access technology, and additionally use a beamforming technology.

Furthermore, according to an embodiment of the disclosure, the next-generation mobile communication system may employ an adaptive modulation & coding (hereinafter referred to as AMC) scheme for determining a modulation scheme and a channel coding rate according to a channel state of a UE. The NR CN 3-05 may perform functions such as mobility support, bearer configuration, and QoS configuration. The NR CN 3-05 is a device responsible for various control functions as well as a mobility management function for a UE, and may be connected to multiple base stations. In addition, the next-generation mobile communication system may interwork with the existing LTE system, and the NR CN 3-05 may be connected to an MME 3-25 via a network interface. The MME 3-25 may be connected to an eNB 3-30 that is an existing base station.

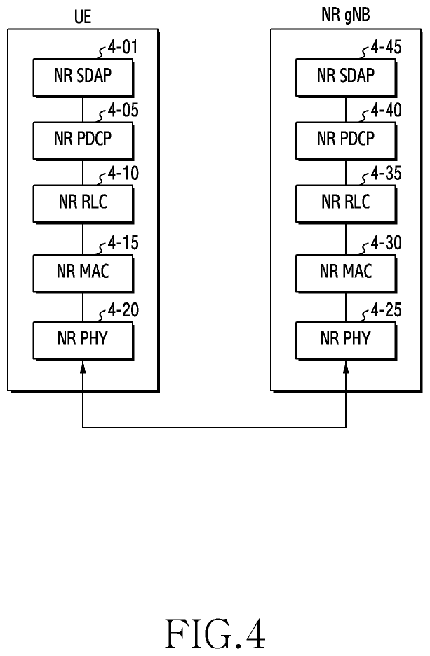

FIG. 4 illustrates a radio protocol structure of a next-generation mobile communication system according to an embodiment of the disclosure.

Referring to FIG. 4, a radio protocol of a next-generation mobile communication system may include an NR service data adaptation protocol (SDAP) 4-01 or 4-45, an NR PDCP 4-05 or 4-40, an NR RLC 4-10 or 4-35, an NR MAC 4-15 or 4-30, and an NR PHY 4-20 or 4-25 in each of a UE and an NR base station. Of course, the radio protocol of the next-generation mobile communication system may include a larger or smaller number of layers than the structure illustrated in FIG. 4.

According to an embodiment of the disclosure, the main functions of the NR SDAP 4-01 or 4-45 may include some of functions below. Obviously, the example given below is not limiting.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP device (or layer, hereinafter interchangeably used with layer or layer device) 4-01 or 4-45, the UE may be configured, through an RRC message, whether to use the header of the SDAP layer device with regard to each PDCP layer device or with regard to each bearer or with regard to each logical channel, or whether to use functions of the SDAP device 4-01 or 4-45. If an SDAP header is configured, the NAS QoS reflection configuration 1-bit indicator (NAS reflective QoS) of the SDAP header and the AS QoS reflection configuration 1-bit indicator (AS reflective QoS) thereof may be indicated by the base station, so that the UE can update or reconfigure mapping information regarding the QoS flow and data bearer of the uplink and downlink. According to an embodiment, the SDAP header may include QoS flow ID information indicating the QoS. Furthermore, according to an embodiment, the QoS information may be used as data processing priority, scheduling information, etc. for smoothly supporting services.

According to an embodiment of the disclosure, the main functions of the NR PDCP 4-05 or 4-40 may include some of functions below. Obviously, the example given below is not limiting.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

According to an embodiment of the disclosure, the reordering of the NR PDCP device 4-05 or 4-40 may refer to a function of reordering PDCP PDU received from a lower layer in an order based on PDCP sequence numbers (SNs). The reordering of the NR PDCP device 4-05 or 4-40 may include at least one of a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

According to an embodiment of the disclosure, the main functions of the NR RLC 4-10 or 4-35 may include some of functions below. Obviously, the example given below is not limiting.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

According to an embodiment of the disclosure, the in-sequence delivery of the NR RLC device 4-10 or 4-35 may refer to a function of successively delivering RLC SDUs received from the lower layer to the upper layer. The in-sequence delivery of the NR RLC device may include a function of reassembling and delivering multiple RLC SDUs received, into which one original RLC SDU has been segmented.

According to an embodiment of the disclosure, the in-sequence delivery of the NR RLC device 4-10 or 4-35 may include at least one of a function of reassembling and delivering multiple RLC SDUs received, into which one original RLC SDU has been segmented, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs.

According to an embodiment of the disclosure, the in-sequence delivery of the NR RLC 4-10 or 4-35 may include at least one of a function of, if there is a lost RLC SDU, sequentially transferring only RLC SDUs before the lost RLC SDU to an upper layer, a function of, although there is a lost RLC SDU, if a predetermined timer has expired, sequentially transferring, to an upper layer, all the RLC SDUs received before the timer is started, and a function of, although there is a lost RLC SDU, if a predetermined timer has expired, sequentially transferring all the RLC SDUs received up to now, to an upper layer.

The in-sequence delivery of the NR RLC device may include a function of, although there is a lost RLC SDU, if a predetermined timer has expired, sequentially transferring, to a higher layer, all the RLC SDUs received before the timer is started.

The in-sequence delivery of the NR RLC device may include a function of, although there is a lost RLC SDU, if a predetermined timer has expired, sequentially transferring all the RLC SDUs received up to the current, to a higher layer.

According to an embodiment of the disclosure, the NR RLC device 4-10 or 4-35 may process RLC PDUs in a reception sequence, regardless of a sequence based on sequence numbers (out-of-sequence delivery). and then transfer the processed RLC PDUs to the NR PDCP device.

According to an embodiment of the disclosure, upon receiving segments, the NR RLC device 4-10 or 4-35 may receive segments stored in a buffer or to be received in the future, reconfigure the segments to be one whole RLC PDU, process the RLC PDU, and then transfer the processed RLC PDU to the NR PDCP device.

According to an embodiment of the disclosure, the NR RLC device 4-10 or 4-35 may include no concatenation function, which may be performed in the NR MAC layer or replaced with a multiplexing function of the NR MAC layer.

The above-mentioned out-of-sequence delivery of the NR RLC device may refer to a function of instantly delivering RLC SDUs received from the lower layer to the upper layer regardless of the order. In addition, the out-of-sequence delivery of the NR RLC device may include a function of, if one original RLC SDU is divided into several RLC SDUs and then the RLC SDUs are received, reassembling the several RLC SDUs and transferring the reassembled RLC SDUs. Furthermore, the out-of-sequence delivery function of the NR RLC device may include a function of storing an RLC sequence number (SN) or a PDCP sequence number (SN) of received RLC PDUs and arranging order to record lost RLC PDUs.

According to an embodiment of the disclosure, the NR MAC device 4-15 or 4-30 may be connected to multiple NR RLC layer devices configured in one UE, and the main functions of the NR MAC 4-15 or 4-30 may include some of functions below. Obviously, the example given below is not limiting.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

According to an embodiment of the disclosure, the NR PHY layer 4-20 or 4-35 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the example given above is not limiting.

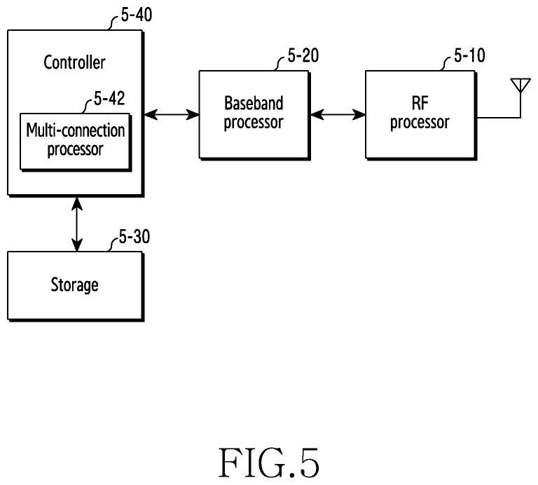

FIG. 5 is a block diagram showing the internal structure of a UE to which the disclosure is applied according to an embodiment of disclosure.

Referring to FIG. 5, the UE may include a radio frequency (RF) processor 5-10, a baseband processor 5-20, a storage 5-30, and a controller 5-40. Of course, it is not limited to the above example, and the UE may include fewer or more elements than those shown in FIG. 5.

The RF processor 5-10 may perform functions for transmitting and receiving signals through a wireless channel, such as band conversion and amplification of signals. That is, the RF processor 5-10 may upconvert a baseband signal provided from the baseband processor 5-20 into an RF band signal and transmit the same through an antenna, and may down-convert the RF band signal received through the antenna into a baseband signal. For example, the RF processor 5-10 may include a transmission filter, a reception filter, an amplifier, a mixer, an oscillator, a digital to analog convertor (DAC), an analog to digital convertor (ADC), etc. In FIG. 5, only one antenna is shown, but the UE may be equipped with multiple antennas. Additionally, the RF processor 5-10 may include multiple RF chains. Furthermore, the RF processor 5-10 may perform beamforming. For beamforming, the RF processor 5-10 may adjust the phase and size of each of signals transmitted and received through multiple antennas or antenna elements. Additionally, the RF processor 5-10 may perform MIMO and may receive multiple layers when performing a MIMO operation. The RF processor 5-10 may perform reception beam sweeping by appropriately configuring multiple antennas or antenna elements under the control of the controller, or may adjust the direction and beam width of the reception beam so that the reception beam coordinates with the transmission beam.

According to an embodiment of the disclosure, the baseband processor 5-20 may perform a conversion function between a baseband signal and a bit stream according to the physical layer standard of the system. For example, when transmitting data, the baseband processor 5-20 may generate complex symbols by encoding and modulating the transmission bit stream. Additionally, when receiving data, the baseband processor 5-20 may restore a received bit stream by demodulating and decoding the baseband signal provided from the RF processor 5-10. For example, in case that the orthogonal frequency division multiplexing (OFDM) scheme is applied, when transmitting data, the baseband processor 5-20 may generate complex symbols by encoding and modulating a transmission bit stream, map the complex symbols to subcarriers, and then configure OFDM symbols through an inverse fast Fourier transform (IFFT) operation and cyclic prefix (CP) insertion. Furthermore, when receiving data, the baseband processor 5-20 may divide a baseband signal received from the RF processor 5-10 in units of OFDM symbols, restore signals mapped to subcarriers through a fast Fourier transform (FFT) operation, and then restore a reception bit stream through demodulation and decoding.

According to an embodiment of the disclosure, the baseband processor 5-20 and the RF processor 5-10 may transmit and receive signals as described above. Accordingly, the baseband processor 5-20 and the RF processor 5-10 may be referred to as a transmitter, a receiver, a transceiver, or a communication unit. Furthermore, at least one of the baseband processor 5-20 and the RF processor 5-10 may include multiple communication modules to support multiple different wireless access technologies. Additionally, at least one of the baseband processor 5-20 and the RF processor 5-10 may include different communication modules to process signals in different frequency bands. For example, different wireless access technologies may include wireless LAN (e.g., IEEE 802.11), cellular network (e.g., LTE), and the like. Additionally, different frequency bands may include a super high frequency (SHF) (e.g., 2.NRHz, NRhz) band and a millimeter wave (mm wave) (e.g., 60 GHZ) band. The UE may transmit and receive signals to and from the base station by using the baseband processor 5-20 and the RF processor 5-10, and the signals may include control information and data.

The storage 5-30 stores data, such as basic programs, application programs, and configuration information for operation of the UE. In particular, the storage 5-30 may store information related to a second access node of performing wireless communication using a second wireless access technology. Additionally, the storage 5-30 provides stored data according to a request from the controller 5-40. Additionally, the storage 5-30 may be configured by multiple memories. According to an embodiment, the storage 5-30 may store a program for performing the conditional PSCell change method described in this disclosure.

According to an embodiment of the disclosure, the controller 5-40 controls overall operations of the UE. For example, the controller 5-40 may transmit and receive signals through the baseband processor 5-20 and the RF processor 5-10. Additionally, the controller 5-40 may write and read data to and from the storage 5-40. To this end, the controller 5-40 may include at least one processor. For example, the controller 5-40 may include a communication processor (CP) of performing control for communication and an application processor (AP) of controlling higher layers such as application programs. Additionally, at least one configuration within the UE may be implemented as a single chip. In addition, according to an embodiment of the disclosure, the controller 5-40 may include a multi-connection processor 5-42 of performing processing to operate in a multi-connection mode.

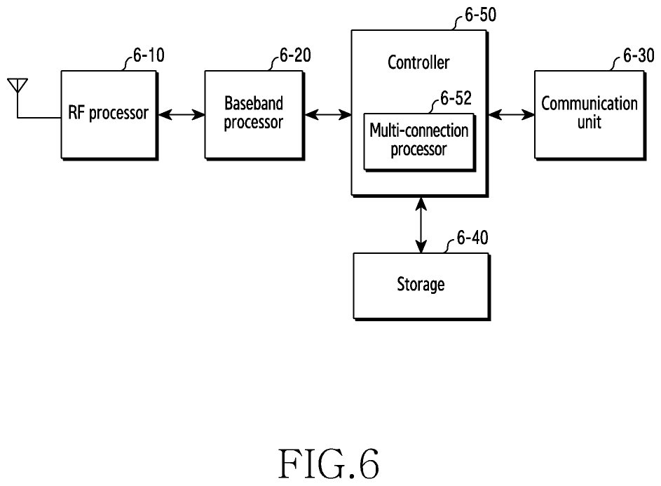

FIG. 6 is a block diagram showing the configuration of an NR base station according to an embodiment of the disclosure.

Referring to FIG. 6, A base station includes an RF processor 6-10, a baseband processor 6-20, a backhaul communication unit 6-30, a storage 6-40, and a controller 6-50. Of course, it is not limited to the above example, and the base station may include fewer or more elements than the configuration shown in FIG. 6.

According to an embodiment of the disclosure, the RF processor 6-10 may perform functions for transmitting and receiving signals through a wireless channel, such as band conversion and amplification of signals. That is, the RF processor 6-10 may upconvert the baseband signal provided from the baseband processor 6-20 into an RF band signal and transmit the same through an antenna, and may down-convert the RF band signal received through the antenna into a baseband signal. For example, the RF processor 6-10 may include a transmission filter, a reception filter, an amplifier, a mixer, an oscillator, a DAC, an ADC, etc. Although only one antenna is shown in FIG. 6, the base station may be equipped with multiple antennas. Additionally, the RF processor 6-10 may include multiple RF chains. Furthermore, the RF processor 6-10 may perform beamforming. For beamforming, the RF processor 6-10 may adjust the phase and size of each of signals transmitted and received through multiple antennas or antenna elements. The RF processor 6-10 may perform downlink MIMO operation by transmitting one or more layers.

According to an embodiment of the disclosure, the baseband processor 6-20 may perform a conversion function between a baseband signal and a bit stream according to the physical layer standard of the first wireless access technology. For example, when transmitting data, the baseband processor 6-20 may generate complex symbols by encoding and modulating the transmission bit stream. Additionally, when receiving data, the baseband processor 6-20 may restore the received bit stream by demodulating and decoding the baseband signal provided from the RF processor 6-10. For example, in case that the OFDM scheme is applied, when transmitting data, the baseband processor 6-20 may generate complex symbols by encoding and modulating the transmission bit stream, map the complex symbols to subcarriers, and then configure OFDM symbols through an IFFT operation and CP insertion. In addition, when receiving data, the baseband processor 6-20 may divide the baseband signal provided from the RF processor 6-10 in units of OFDM symbols, restore the signals mapped to subcarriers through FFT operation, and then restore a reception bit stream through demodulation and decoding. The baseband processor 6-20 and the RF processor 6-10 transmit and receive signals as described above. Accordingly, the baseband processor 6-20 and the RF processor 6-10 may be referred to as a transmitter, a receiver, a transceiver, a communication unit, or a wireless communication unit.

According to an embodiment of the disclosure, the communication unit 6-30 may provide an interface for communicating with other nodes in the network. In other words, the communication unit 6-30 may convert a bit stream transmitted from the main base station to another node, for example, an auxiliary base station, a core network, etc., into a physical signal, and convert a physical signal received from another node into a bit stream.

The storage 6-40 stores data, such as basic programs, applications, and configuration information for the operation of the main base station. Specifically, the storage 6-40 may store information about a bearer allocated to an accessed UE, measurement results reported by the accessed UE, and the like. Additionally, the storage 6-40 may store information that serves as a criterion for determining whether to provide a UE with multiple connections or interrupt the connection. Additionally, the storage 6-40 may provide stored data according to a request from the controller 6-50. The storage 6-40 may be configured by a storage medium, such as a read only memory (ROM), a random access memory (RAM), a hard disk, a compact disc read only memory (CD-ROM), and a digital versatile disc (DVD), or a combination of storage media. Additionally, the storage 6-40 may be configured by multiple memories. According to an embodiment, the storage 6-40 may store a program for performing the conditional pscell change method described in this disclosure.

The controller 6-50 may control the overall operations of the base station. For example, the controller 6-50 may transmit and receive signals through the baseband processor 6-20 and the RF processor 6-10 or through the backhaul communication unit 6-30. Additionally, the controller 6-50 may write and read data to and from the storage 6-40. To this end, the controller 6-50 may include at least one processor. Additionally, at least one element of the base station may be implemented as a single chip. According to an embodiment of the disclosure, the controller 6-50 may include a multi-connection processor 6-52 that performs processing to operate in a multi-connection mode. Additionally, the controller 6-50 may control the operation of a base station or an entity corresponding thereto according to various embodiments of the disclosure.

Hereinafter, terminologies used in embodiments of the disclosure may be as follows.
CPAC: conditional PSCell addition and change
subsCPAC: subsequent CPAC. This may be an operation such that, after a network setup, when radio signal-based conditions between configured multiple candidate PSCells are satisfied, a UE may perform subsequent movement with no separate network instructions. In this case, when the UE moves to one candidate PSCell, the UE may not remove the condition information related to the configuration of a corresponding target PSCell and the movement to the corresponding target PSCell after the completion of the movement, unless otherwise instructed by the network.
MN: master node
SN: secondary node
S-MN: source MN
S-SN: source SN
T-MN: target MN
T-SN: target SN

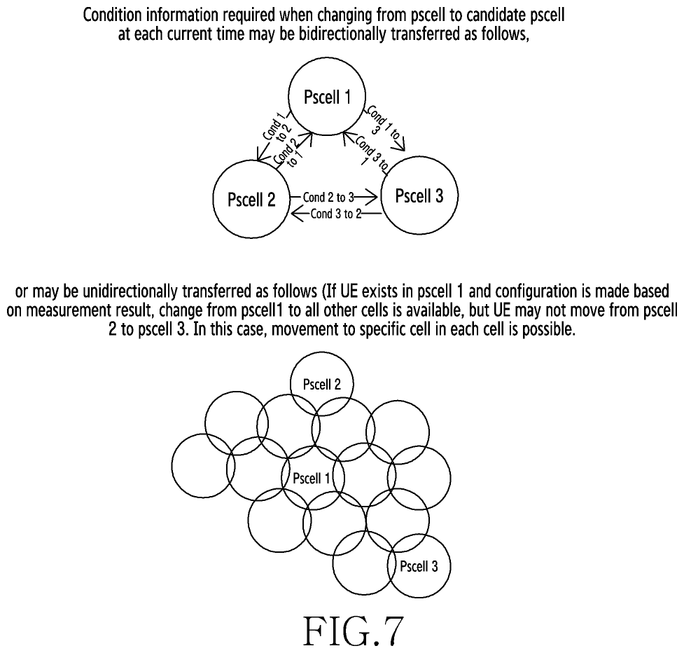

FIG. 7 illustrates configurations of candidate PSCells given based on subsCPAC configurations and a condition relationship between the configurations according to an embodiment of disclosure.

The first diagram (e.g., the upper diagram of FIG. 7) may represent a case in which PSCells 1, 2, and 3 are given based on the configuration information of subsCPAC and in this case, UE movement between respective candidate cells is allowed. Accordingly, the conditions for movement between respective PSCells may be displayed.

On the other hand, the second drawing (e.g., the lower diagram of FIG. 7) shows a case in which the UE is allowed to move to a specific candidate cell, but not to another candidate cell. For example, it may be possible for a UE to exist in PSCell 1and then move to PSCell 2 or PSCell 3. However, it is less likely for a UE to exist in PSCell 2 and then move to PSCell 3. Therefore, even for a cell in which all subsCPACs are allowed, all inter-cell movement may be possible or conditions for movement may not be required.

According to the method proposed in this disclosure, implementation of both of the above-described cases is possible, and the required signaling elements may not be configured.

However, in the CPAC signaling system, CPAC configuration information to be transferred to the UE may be configured by conditions (e.g., including at least one of an entering condition, target cell configuration information to be applied in the corresponding PSCell, or an identity (ID)) that are satisfied when moving from a current source PSCell to a candidate PSCell. The network (e.g., MN) may organize a list of sets of the above-described conditions (e.g., including at least one of the ID, target cell configuration information, or condition information) and transfer the same to the UE as information about the multiple candidate PSCells. In preparation for transferring the information about multiple candidate PSCells, the subsCPAC allows the MN to transfer to the UE a set/list including at least one of the target cell configuration information, movement condition information associated with the target cell configuration information, and an ID. In this case, the condition information associated with the target cell configuration information may be condition information required for movement to a target cell or condition information required for movement from the target cell to another cell.

In SN initiated CPC, only pieces of related information as follows may be included in following messages.

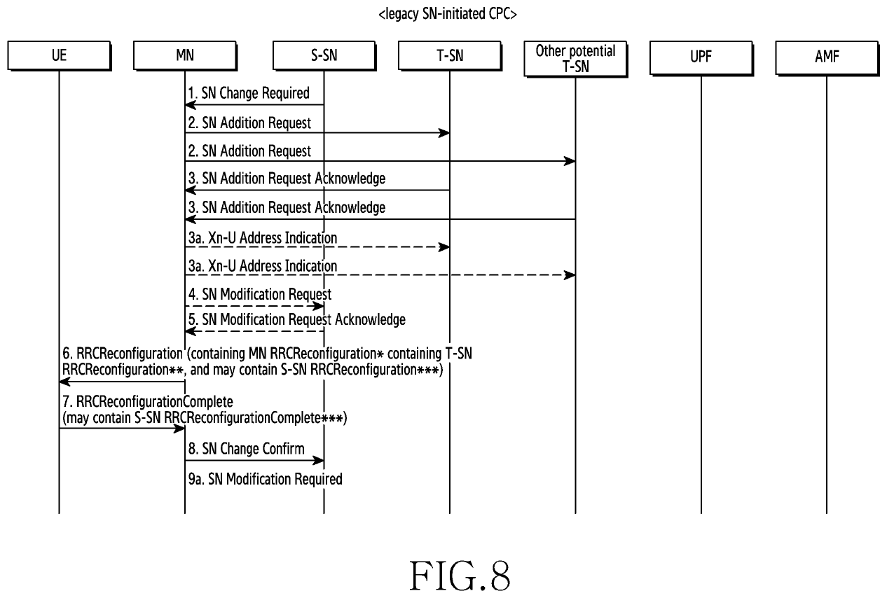

FIG. 8 is a flow diagram of SN initiated CPC according to an embodiment of the disclosure.

Referring to FIG. 8,
SN change required message may include at least one of the following pieces of information.
   Target SN ID list and CG-Config information for each target SN.
      The CG-Config field may include, as an RRC inter node message, information on cells that the S-SN proposes as a candidate PSCell corresponding to each SN to perform CPC (CandidateCellInfoListCPC-r17).
      The CG-Config field may include results of cell strength measurement by a UE, for cells proposed as candidate PSCells corresponding to each target SN. At this time, admission control of respective cells may be performed based on the measurement result (candidateCellInfoListSN-r15).

```
  CandidateCellInfoListCPC-r17 ::= SEQUENCE (SIZE (1..maxFreq))
OF CandidateCellInfo-r17
  CandidateCellInfo-r17 ::= SEQUENCE {
    ssbFrequency-r17 ARFCN-ValueNR,
    candidateList-r17 SEQUENCE (SIZE (1..maxNrofCondCells-r16)) OF
CandidateCell-r17
  }
  CandidateCell-r17 ::= SEQUENCE {
    physCellId-r17 PhysCellId,
    condExecutionCondSCG-r17 OCTET STRING (CONTAINING
CondReconfigExecCondSCG-r17)
```

The MN may transmit an SN AddReq message to each candidate SN, and here, the CG-Config field may be included.
The candidate SN that has received the SN AddReq message may determine an admitted PSCell by considering measurement information among the proposed cells.
Each candidate SN may transfer the SN ADDReqACK message to the MN in response to the SN AddReq message. Here, the determined admitted PSCell including CG-CandidateList may be notified of.

Hereinafter, an embodiment of the disclosure proposes a method for configuration of SN initiated subs CPAC.

At least one of the basic assumptions or elements of the SN-initiated case may be included.
Initial conditions may be generated by a source SN.
The type of condition may include event A3/5.
Information required for the source SN to generate the above-mentioned conditions: Frequency of candidate PSCells
Subs CPAC conditions: this may be generated by each candidate SN that operates a candidate PSCell.
   The type of condition may include event A3/5.
   Information required for each candidate SN to generate the above-mentioned conditions:
      Information indicating that another candidate SN has admitted a UE for subs CPAC. Based on the information indicating that another candidate SN has admitted a UE for subs CPAC, it may be assumed that each candidate SN moves from its own PSCell to the admitted PSCell of another candidate SN. Based on the above-mentioned assumption, each candidate SN may make conditions that may be used when moving from its own target PSCell to the admitted candidate PSCell of the other candidate SN. In an embodiment, when making subs CPAC configuration, it may be assumed that each candidate SN may bi-directionally configure subs CPAC for each candidate PSCell configured for the UE (upon receiving an Xn message including the first subsCPAC indicator, each candidate SN may need to perform an operation corresponding to the subsCPAC indicator).
      Information (physical cell ID (PCI) and/or absolute radio frequency channel number (ARFCN) information) of the admitted candidate PSCell of another candidate SN may be required. In addition, when each candidate SN makes a condition through frequency information (e.g., ARFCN), a measurement object (MO) associated with the corresponding event (e.g., event A3/5) may be configured. In addition, each candidate SN may need to configure the measurement and transfer ID information to the UE.

In the following, options for inter node signaling to perform the basic element operations described above are described.

Opt. 2 Each candidate SN may proactively make condition information regardless of the admission result, with respect to the candidate PSCell information of all candidate SNs proposed by the S-SN, and thereafter the MN may take the condition information through filtering. Additionally, this may be a method of including as much necessary information as possible in the inter node message of the legacy SN initiated (SI)-CPC procedure.

The S-SN may perform admission control for not only the DC-configured PSCell of the current UE, but also candidate PSCells operated by the S-SN for additional subsCPAC uses, and may include the admitted PSCell information (e.g., PCI and/or frequency information ARFCN) in an Xn message (e.g., SNChangeRequired message) which is transferred from the S-SN to the MN and transfer the same to the MN. In this case, the candidate PSCell may refer to a cell, which is determined by the S-SN that may be used as a candidate PSCell when performing the subs CPAC from another candidate SN to the S-SN.
The Xn message may be used as an SNChangeRequried message in the initial process for preparing subsCPAC.
The information transferred by the S-SN to the MN may include at least one of the following pieces of information.
   Based on the measurement result information received by the SN from the UE, a list of candidate PSCells that may be considered by each SN (e.g., legacy information, from which each candidate SN may down select candidate PSCells for subsCPAC), the legacy CandidateCellInfoListCPC IE
   Information of admitted candidate PSCell: a cell that is available as a target cell and/or a source cell for subsCPAC among cells operated by the S-SN, and each cell may include at least one of the following pieces of information.
      PCI, CGI (NR) ARFCN, and/or cell/beam measurement result values measured by the UE
      which may be included in CG-Config, a separate RRC inter node signaling message (INM), or Xn field.
   PCI/AFRCN/frequency information and cell-based and/or beam-based measurement result information for candidate PSCells proposed by all S-SNs of all other candidate SNs.

The MN that has received the Xn message may transfer, to the indicated target SNs (e.g., a list of candidate SNs) including a list of candidates received from the S-SN, an Xn SNAddReq message by including at least one of the following.
Relevant information of the admitted candidate PSCell of the S-SN (including at least one of PCI/ARFCN/measurement results) may be included in the Xn SNAddReq message and transmitted. [A]
Transfer all candidate PSCell lists of all candidate SNs transferred by the S-SN (e.g., in the case of legacy CPC, only a candidate PSCell list [B] corresponding to a specific SN is transferred, whereas according to embodiments of the disclosure, all candidate PSCell lists of all SNs [C] are transferred). In other words, CandidateCellInfoListCPC with target SN ID for all candidate SNs is transferred.

The candidate SN (SN2) that has received the Xn message may perform admission control (down select) based on the candidate PSCell list for the candidate SN itself among the candidate lists for all candidate SNs [C]. In addition, the candidate SN (SN2) that has received the Xn message may make conditions for its own the admitted candidate PSCells to move to a cell belonging in the admitted cell list [A] received from the S-SN, as a target cell to perform subsCPAC on the corresponding cell.

In addition, for the candidate PSCell list of SNs excluding the SN itself from all candidate PSCell lists [C] included in all other candidate SNs (e.g., S-SN and other candidate SNs excluding the SN itself), when the corresponding cell is considered as a target cell and the admitted cell of the SN itself is considered as a source cell, required subsCPAC performance conditions may be determined and/or made.
The above-described conditions may be implemented by MO, reportconfig, and/or measId in a measurement configuration among CPAC configurations of admitted PSCells of a candidate SN corresponding to a source PSCell of the condition.
   According to the above-mentioned conditions, the frequency corresponding to the target cell may be configured as a measurement object, event information for conditional mobility corresponding to event A3/4/5 may be configured in the report configuration, and the measurement object may be associated with the report configuration by one measurement ID and thereafter the same is included in the measurement configuration within the configuration information of the source PSCell.
The condition information described above may require association of the corresponding source cell information (e.g., including at least one of the PCI, the AFRCN, and the order or assigned IDs in the list/set structure of all candidate PSCells of all candidate SNs received from the S-SN) with the target cell information (e.g., including at least one of the PCI, the ARFCN, and the order or assigned IDs in the list/set structure of all candidate PSCells of all candidate SNs received from the S-SN).
Previously made admitted PSCell information, condition information for movement from the corresponding PSCell regarded as a source to all other candidate PSCells regarded as a target, and configuration information to be used in the admitted PSCell may be included in the SNAddReqACK message and transferred to the MN.
There may be a proactive method for making CPAC conditions by assuming that all cells of the candidate PSCell list of SNs excluding the SN itself from [C] have been admitted, without knowing the result of admission. Using the above-described method, multiple conditions exist within the CPAC target cell configuration, and thus an MO exceeding UE capacity may be used.

The above-described operation may be performed in the S-SN in the same manner as that of SN3.

After collecting the information included in the SNAddReqACK message from all candidate SNs, the MN may identify a PSCell candidate actually admitted by each SN. In addition, the MN may regard, as a target cell, the identified actual admitted PSCell, based on proactive condition information made by each SN. The MN may, through filtering, take only conditions for a source cell and exclude the rest from pieces of condition information transferred to the UE. Here, the filtering process may signify a process in which only configuration information of a final admitted PSCell is included in the subsCPAC configuration information transferred to the UE and, from among proactive conditions, condition information by which the admitted PSCell is not indicated as a target cell and/or a source cell is removed.

Therefore, the RRCReconfiguration message of the MN transferred to the UE may include, as subsCPAC configuration information, a list of {condReconfig ID, candidate PSCell configuration information, and at least one of multiple pieces of condition information associated with the candidate PSCell (e.g., a condition in which a candidate PSCell is a source and for movement to another candidate PSCell, or a condition in which a candidate PSCell is a target and for movement to the target cell from another candidate PSCell).

At this time, multiple pieces of condition information for one candidate PSCell may refer to conditions of performing an operation for moving to the candidate PSCell (or applying the corresponding candidate PSCell configuration information) or moving from the candidate PSCell. Additionally, different conditions may be used depending on a PSCell of the UE at the time of performing the above-described operation.

Although a configuration of obtaining condition information through filtering is transferred to the UE, the measurement configuration of each candidate PSCell still includes measurement information configured corresponding to the conditions for all possible candidate PSCells, and thus the UE may need to perform unnecessary measurements every time. Although measurement is performed, mapping between measurement and condition evaluation operations does not occur, and thus the UE does not evaluate conditions for each measurement. Therefore, after receiving all SNAddReqACK messages from the corresponding SN, the MN may report the final admitted PSCell result to each SN again. The MN may notify each candidate SN and S-SN of at least one of PCI of the admitted PSCell, ARFCN, or an ID of the admitted PSCell (when the first S-SN has assigned an ID to the candidate PSCell and transfer the same to the MN), by using the Xn message. Alternatively, the MN may map, instead of an ID, a 1-bit indicator indicating “admitted or not admitted” to a list or set associated with the ordering information of the candidate cell list, notified of by the S-SN to the MN, or may write Boolean information on the list/set to transfer the same to the S-SN.

Upon receiving the information described above, SNs may include, in the PSCell configuration, a measurement configuration obtained by removing the measurement (measId), MO, and reportconfig for the PSCell conditions from the configuration information of the PSCells the SNs themselves have admitted, after leaving the measurement information for the admitted PSCell only. Each SN may transfer the changed PSCell configuration again to the MN, by using the Xn message.

The MN may transfer the changed PSCell configurations (by collecting the same) to the UE.

The UE may update the PSCell configurations corresponding to the IDs indicated by the changed PSCell configurations.

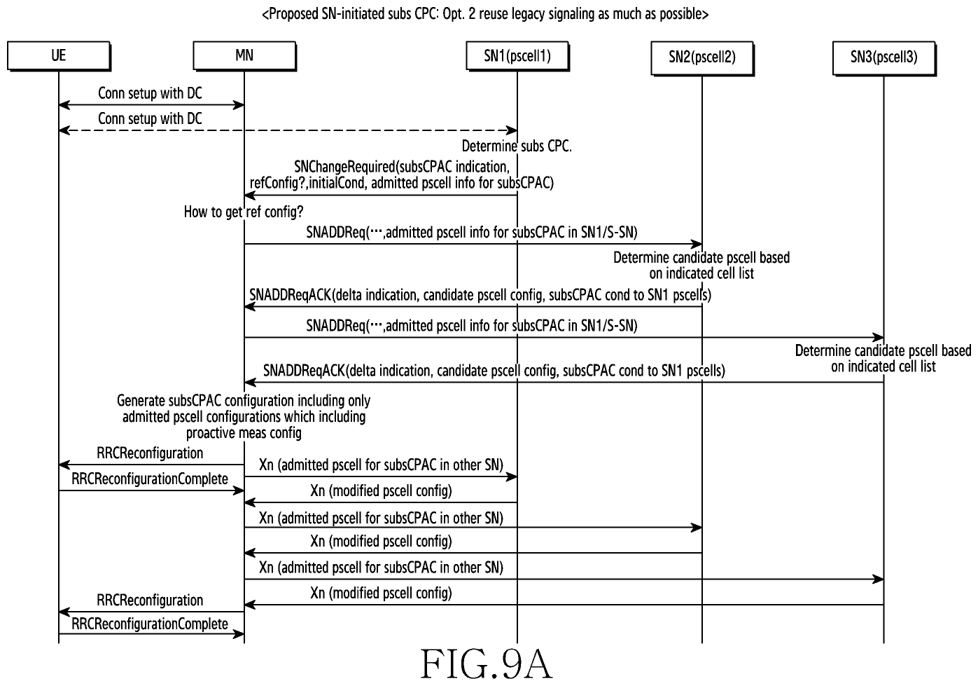

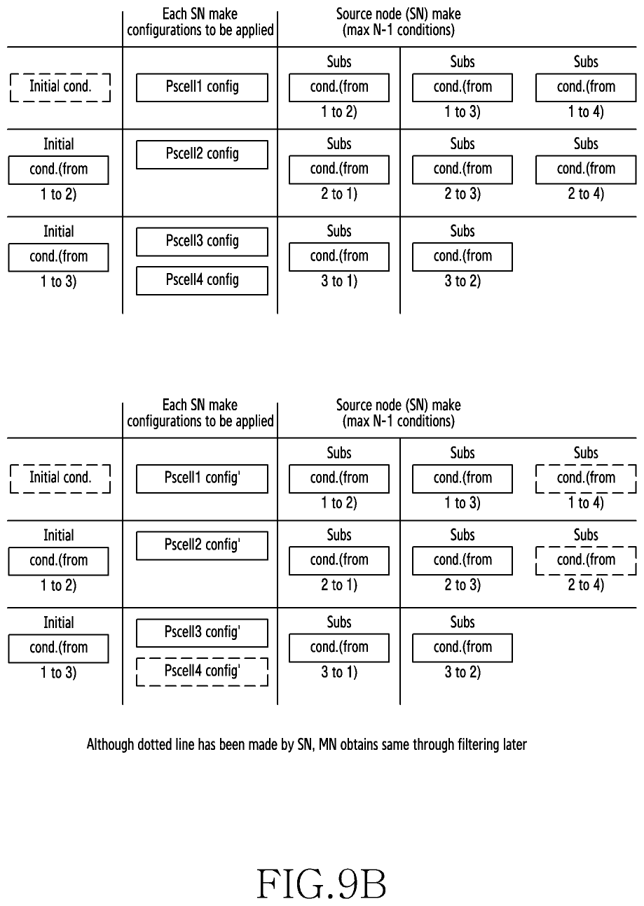

FIG. 9A is a flow diagram of an option according to an embodiment of the disclosure. Further, FIG. 9B is a conceptual diagram related to an option according to an embodiment of the disclosure.

The UE may have a dual connection with MN and SN1.

Thereafter, when an S-SN, that is, SN1 is determined to perform subsCPAC configuration for a UE, the S-SN transmits, to the MN, an SNChangeRequired message including at least one of a subsCPAC indicator for a UE, information about candidate PSCells admitted by the S-SN itself, proposals for candidate PSCells of other candidate SNs, condition information (initial condition) required to move from a current PSCell to candidate PSCells of the proposed candidate SNs, or condition information (subsequent condition) required to move from the admitted candidate PSCell to the candidate PSCells of the proposed candidate SNs.

Information transmitted to the MN may include reference configuration information that may be used when candidate SNs make PSCell configuration information. Based on the reference configuration information, each candidate SN may perform delta signaling for the PSCell configuration information.

The MN that has received information from the S-SN may transmit an SNADDReq message to each candidate SN. Pieces of information included in the SNADDReq message may be the same as the descriptions above (e.g., descriptions regarding [A] to [C]).

Candidate SNs may perform admission control on PSCells proposed to the candidate SNs itself and make conditions to be used when moving from admitted PSCells to other candidate PSCells. In addition, candidate SNs may make PSCell configuration information for each of admitted PSCells. Candidate SNs may transfer the PSCell configuration information again to the MN through the SNAddReqACK message.

The MN may receive the admitted PSCell information from each candidate SN, and may obtain, through filtering, movement conditions to non-admitted cells, among pieces of condition information made by each candidate SN. The MN may transfer, to the UE, configuration information of the admitted PSCells by including pieces of condition information relating thereto. At this time, the PSCell configuration information may still include measurement configurations corresponding to all proactive conditions.

The UE that has received the message from the MN may store configurations, and may perform evaluation of the initial condition based on the current PSCell measurement configurations.

Thereafter, the MN may transfer the admitted PSCell information received from each candidate SN again to each SN. Based on the transferred information, each SN may re-update the PSCell configuration, from which the measurement configurations associated with proactive conditions included in the PSCell configuration information which has been made by the SN itself are removed, and may transfer the updated PSCell configuration information again to the MN. At this time, the Xn message may be used as a signal between the MN and each candidate SN.

The MN may collect pieces of the updated PSCell configuration information and transfer the same again to the UE. The UE may receive the collected pieces of PSCell configuration information and modify the legacy PSCell configuration information into updated PSCell configuration information.

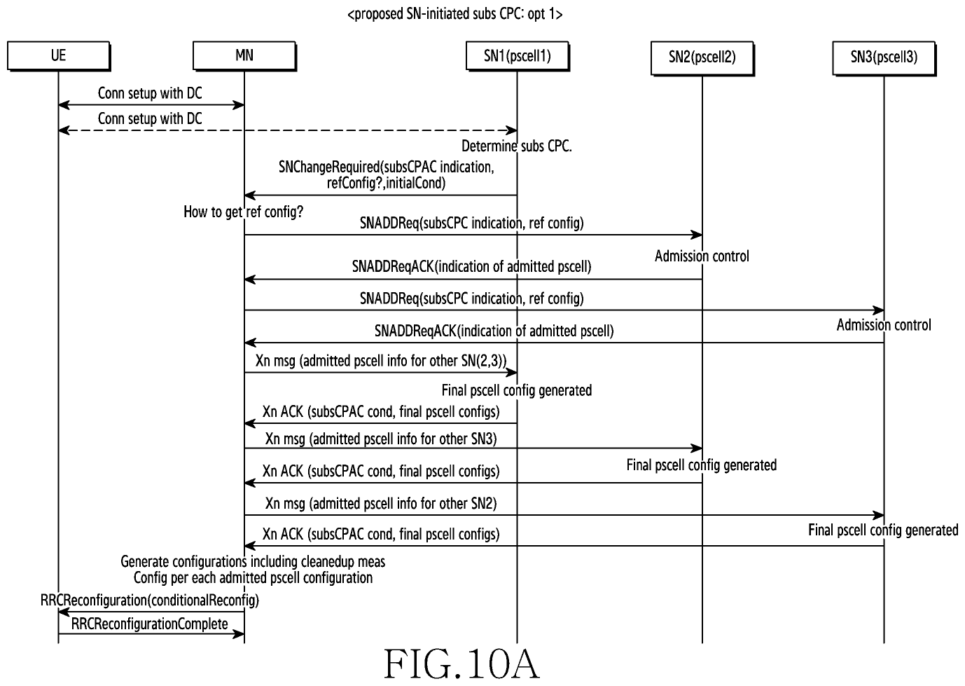

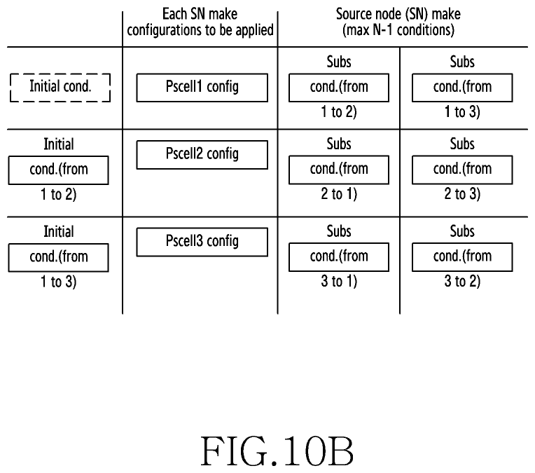

FIG. 10A is a flow diagram of an option according to an embodiment of the disclosure. Specifically, FIG. 10A shows the flow of operations regarding option 1. FIG. 10B is a conceptual diagram related to an option according to an embodiment of the disclosure.

Referring to FIGS. 10A and 10B, an option according to an embodiment of the disclosure may refer to a case in which only the initial condition is made in response to the legacy SN-initiated CPC signal, and thereafter the admitted PSCell information is exchanged and subsequent conditions are made through separate signaling.

Opt. 1 After the Legacy SI-CPC procedure, additional inter node signals may be used. For example, after the process for SNChangeRequired, SNAddReq, and SNAddReqACK messages, admitted candidate PSCells are finally determined in each SN, and then the MN that has obtained the above information may request conditions from the candidate SN by using separate inter node signaling and transfer subsCPAC condition information to the UE.
At this time, the initial condition and candidate PSCell configuration association information may be transferred to the UE first. Thereafter, information collected through inter node messages added to the UE (e.g., subsCPAC condition information for admitted candidate PSCells) may be added to conditions associated with a predetermined candidate PSCell configuration.
Referring to FIGS. 10A and 10B, the admitted PSCell information for other SNs included in the Xn message transferred by the MN to each SN may include at least one of PCI for each admitted PSCell, ARFCN, or a structural ID used when the previous S-SN transfers information of candidate cell to the MN.
In this case, there is an advantage in that the UE may perform measurement and evaluation of the initial condition first.
Further, in inter node signaling after transferring the initial condition to the UE, the candidate SN may, based on the measurement results of respective proactive candidate PSCells transferred by the UE, down select a candidate PSCell that may serve as a target, when considering a specific PSCell of its own (e.g., a candidate SN) as a source, among cells for the predetermined admitted PSCell information for other SN.
Additionally, the candidate SN may make performance condition information by considering the down-selected PSCell as a target. The performance condition information may be implemented on the measConfig made by the SN. At least one of Meas ID, MO, or report Config may be used.
Information on the condReconfig field transferred to the UE may include initial cond and subsequent cond information as condReconfig ID and condition information. Information on the condReconfig field may be associated with one target candidate PSCell configuration.

The UE may have a dual connection with MN and SN1.

Thereafter, when the S-SN (e.g., SN1) is determined to perform subsCPAC configuration for the UE, the S-SN transmits, to the MN, an SNChangeRequired message including at least one of a subsCPAC indicator configured for the UE, information about candidate PSCells admitted by the S-SN, proposals for candidate PSCells of other candidate SNs, condition information (initial condition) required to move from a current PSCell to candidate PSCells of the proposed candidate SNs, or condition information (subsequent condition) required to move from the admitted candidate PSCell to the candidate PSCells of the proposed candidate SNs.

Information having been received from the S-SN may include reference configuration information that may be used when candidate SNs make PSCell configuration information. Based on the reference configuration information, each candidate SN may perform delta signaling for the PSCell configuration information.

The MN that has received information from the S-SN may transmit an SNADDReq message to each candidate SN. Pieces of information included in the SNADDReq message may be the same as the descriptions in the above (e.g., description [A] to [C]).

Candidate SNs may perform admission control on PSCells proposed to the candidate SNs itself, and may make PSCell configuration information to be used when moving to admitted PSCells and transmit the same to the MN. At this time, the PSCell configuration information may include measurement configurations considering movement to all proactive candidate PSCells.

The MN may receive admitted PSCell information from each candidate SN. Additionally, the MN may transfer, to the UE, the admitted PSCell information by including condition information related to configuration information of admitted PSCells. At this time, the PSCell configuration information may still include measurement configurations corresponding to all proactive conditions.

A UE that has received a message including pieces of condition information related to the configurations information of admitted PSCells may store the configurations, and may perform an evaluation of the initial condition based on the current PSCell measurement configurations.

Thereafter, the MN may transfer the admitted PSCell information received from each candidate SN again to each SN.

Based on the admitted PSCell information, each SN may re-update the PSCell configurations obtained by removing the measurement configurations associated with the proactive conditions included in the PSCell configuration information that the SN itself has made. Additionally, each SN may transfer the updated PSCell configuration information again to the MN. Additionally, each SN may consider its own admitted PSCell as a source and make conditions (e.g., subsequent conditions) to be used when moving to other admitted candidate PSCells. Each SN may transfer the pieces of made information again to the MN through the SNAddReqACK message.

In this case, the Xn message may be used as a signal between the MN and each candidate SN.

The MN may collect the updated PSCell configuration information and pieces of condition information for movement to admitted PSCells and transfer the same again to the UE. The UE may receive the collected information and modify the legacy PSCell configuration information into the updated PSCell configuration information. Additionally, the UE may receive condition information (e.g., subsequent condition information) to be considered when moving from each admitted PSCell regarded as a source to a target PSCell.

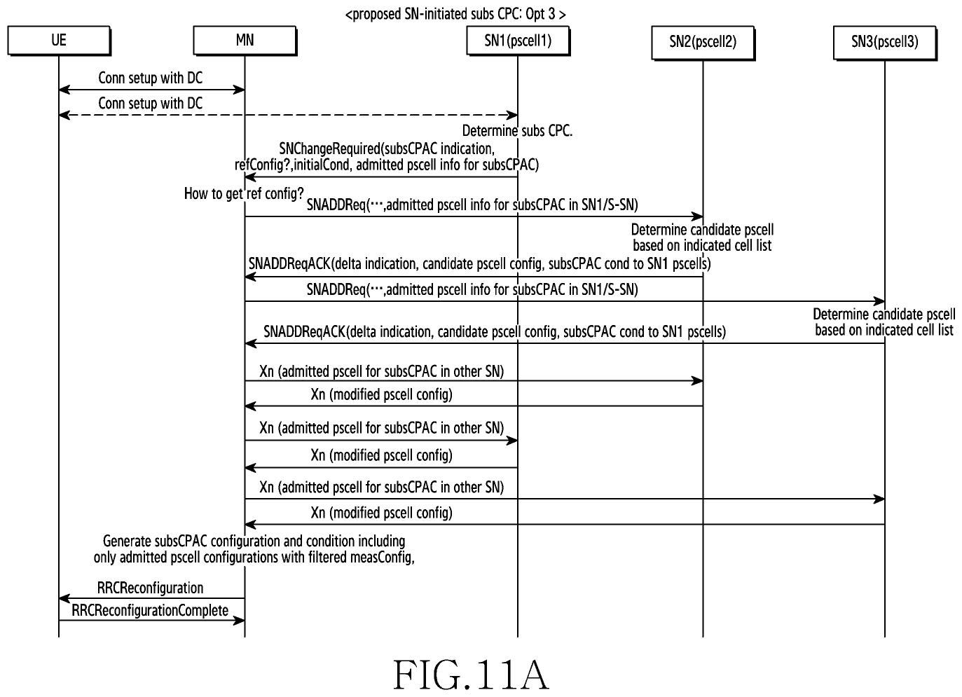

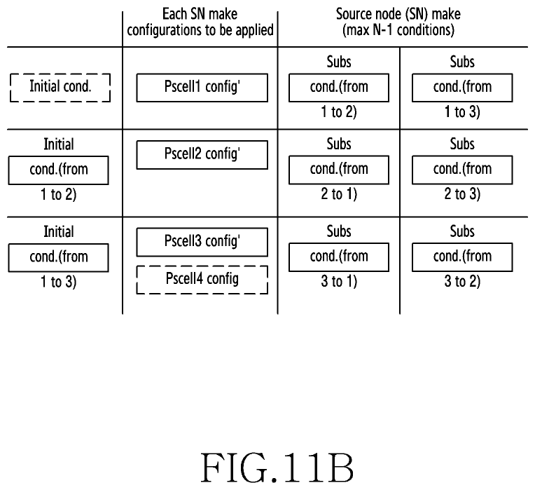

FIG. 11A is a flow diagram of an option according to an embodiment of the disclosure. Specifically, FIG. 11A shows the flow of operations regarding option 3. FIG. 11B is a conceptual diagram related to an option according to an embodiment of the disclosure.

Opt. 3 In connection with an inter node message, in opt 2, the MN transfers initial configuration information to the UE, and thereafter has performed additional operations to clean up the measurement configuration. However, opt 3 may be done before the MN transfers the above-described additional operations to the UE. Here, the MN may include, in the measurement configuration of each PSCell configuration, only configuration information of final admitted PSCells, conditions when the admitted PSCell regarded as a target (subsequent condition), and condition information required when moving to another admitted PSCell with reference to the current PSCell (initial condition).

Referring to FIGS. 11A and 11B, in opt 2, the first RRCReconfiguration message transferred by the MN to the UE and the RRCReconfigurationComplete message transferred by the UE to the MN may not exist. For example, after pieces of information on the final admitted PSCells are collected, the MN may transmit, to the UE, the collected information by including at least one of PSCell configuration information or condition information required for movement to a PSCell corresponding to the configuration information.

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored to a memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure. In the specific embodiments of the disclosure, the components included in the disclosure are expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

Meanwhile, while the specific embodiment has been described in the explanations of the disclosure, it will be noted that various changes may be made therein without departing from the scope of the disclosure. Therefore, the scope of the disclosure is not limited and defined by the described embodiment and is defined not only the scope of the claims as below but also their equivalents.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of embodiment 1 of the disclosure may be combined with a part of embodiment 2 to operate a base station and a terminal. Furthermore, although the above embodiments have been presented based on the frequency division duplex (FDD) LTE system, other variants based on the technical idea of the above embodiments may also be implemented in other systems such as time division duplex (TDD) LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a master node (MN) in a wireless communication system, the method comprising:
receiving, from a source secondary node (S-SN), a secondary node (SN) change required message for initiating a subsequent conditional primary secondary cell group cell (PSCell) addition and change (CPAC);
transmitting, to a plurality of candidate SNs, an SN addition request message including at least one of a list of PSCell candidates for the plurality of candidate SNs or information on the plurality of candidate SNs;
receiving, from the plurality of candidate SNs, an SN addition request acknowledge message including at least one of information on at least one PSCell among the list of the PSCell candidates or information on a first execution condition for the at least one PSCell;
transmitting, to the S-SN and the plurality of candidate SNs, the information on the at least one PSCell; and
receiving, from the plurality of candidate SNs, first information on an updated configuration for the at least one PSCell.

2. The method of claim 1, wherein the SN change required message includes at least one of information indicating the subsequent CPAC, the list of the PSCell candidates, or information on a second execution condition for the PSCell candidates.

3. The method of claim 1, wherein the information on the at least one PSCell includes an identifier of the at least one PSCell.

4. The method of claim 1, further comprising:
receiving, from the S-SN, second information on an updated measurement configuration for the S-SN.

5. The method of claim 4, further comprising:
transmitting, to a user equipment (UE), a radio resource control (RRC) reconfiguration message including the first information and the second information.

6. The method of claim 1, wherein the first execution condition is for a following execution of the subsequent CPAC.

7. The method of claim 2, wherein the second execution condition is for an initial evaluation.

8. A method performed by a secondary node (SN) in a wireless communication system, the method comprising:
receiving, from a master node (MN), an SN addition request message including at least one of a list of PSCell candidates for a plurality of candidate SNs or information on the plurality of candidate SNs;
identifying at least one PSCell among the list of the PSCell candidates;
transmitting, to the MN, an SN addition request acknowledge message including at least one of information on the at least one PSCell or information on a first execution condition for the at least one PSCell;
receiving, from the MN, the information on the at least one PSCell; and
transmitting, to the MN, first information on an updated configuration for the at least one PSCell.

9. The method of claim 8, wherein the information on the at least one PSCell includes an identifier of the at least one PSCell.

10. The method of claim 8, wherein the first execution condition is for a following execution of a subsequent conditional primary secondary cell group cell (PSCell) addition and change (CPAC).

11. A master node (MN) in a wireless communication system, The MN comprising:
a transceiver; and
at least one processor coupled with the transceiver and configured to:
receive, from a source secondary node (S-SN), a secondary node (SN) change required message for initiating a subsequent conditional primary secondary cell group cell (PSCell) addition and change (CPAC),
transmit, to a plurality of candidate SNs, an SN addition request message including at least one of a list of PSCell candidates for the plurality of candidate SNs or information on the plurality of candidate SNs,
receive, from the plurality of candidate SNs, an SN addition request acknowledge message including at least one of information on at least one PSCell among the list of the PSCell candidates or information on a first execution condition for the at least one PSCell,
transmit, to the S-SN and the plurality of candidate SNs, the information on the at least one PSCell, and
receive, from the plurality of candidate SNs, first information on an updated configuration for the at least one PSCell.

12. The MN of claim 11, wherein the SN change required message includes at least one of information indicating the subsequent CPAC, the list of the PSCell candidates, or information on a second execution condition for the PSCell candidates.

13. The MN of claim 11, wherein the information on the at least one PSCell includes an identifier of the at least one PSCell.

14. The MN of claim 11, wherein the at least one processor is further configured to:
receive, from the S-SN, second information on an updated measurement configuration for the S-SN.

15. The MN of claim 14, wherein the at least one processor is further configured to:
transmit, to a user equipment (UE), a radio resource control (RRC) reconfiguration message including the first information and the second information.

16. The MN of claim 11, wherein the first execution condition is for a following execution of the subsequent CPAC.

17. The MN of claim 12, wherein the second execution condition is for an initial evaluation.

18. A secondary node (SN) in a wireless communication system, the SN comprising:
a transceiver; and
at least one processor coupled with the transceiver and configured to:
receive, from a master node (MN), an SN addition request message including at least one of a list of PSCell candidates for a plurality of candidate SNs or information on the plurality of candidate SNs,
identify at least one PSCell among the list of the PSCell candidates,
transmit, to the MN, an SN addition request acknowledge message including at least one of information on the at least one PSCell or information on a first execution condition for the at least one PSCell,
receive, from the MN, the information on the at least one PSCell, and
transmit, to the MN, first information on an updated configuration for the at least one PSCell.

19. The SN of claim 18, wherein the information on the at least one PSCell includes an identifier of the at least one PSCell.

20. The SN of claim 18, wherein the first execution condition is for a following execution of a subsequent conditional primary secondary cell group cell (PSCell) addition and change (CPAC).
